(19) United States
(12) Patent Application Publication
(10) Pub. No.: US 2013/0187519 A1
(43) Pub. Date: Jul. 25, 2013

(54) BALANCEABLE ROTATION ELEMENT

(71) Applicants: Klaus Linnenbrock, Changsha (CN); Julien Casagrande, Rheinau-Freistett (FR); Tobias Schneider, Ottersweier (DE)

(72) Inventors: Klaus Linnenbrock, Changsha (CN); Julien Casagrande, Rheinau-Freistett (FR); Tobias Schneider, Ottersweier (DE)

(73) Assignee: ROBERT BOSCH GMBH, Stuttgart (DE)

(21) Appl. No.: 13/701,743

(22) PCT Filed: May 10, 2011
(86) PCT No.: PCT/EP2011/057451

§ 371 Date: Mar. 6, 2013

(30) Foreign Application Priority Data
Jun. 1, 2010 (DE) 10 2010 029 545.0

(51) Int. Cl. H02K 7/04

(52) U.S. Cl. CPC H02K 7/04
USPC 310/75 R; 310/96; 310/90

(57) ABSTRACT

A moving element is connected to a rotor of an electric motor in a manner locked in terms of torque and, together with the rotor, forms a rotation element. An angle of inclination of the moving element in relation to the rotor is defined by bearing elements which are arranged on a circumference about the axis of rotation of the rotor, wherein the bearing elements each define axial distances between the rotor and the moving element. Each bearing element is formed by a first and a second axial section, and the moving element can be brought into different rotational positions in relation to the rotor so as to produce different pairings of the first and second sections, said pairings corresponding to different angles of inclination.

### BACKGROUND OF THE INVENTION

Electric motors comprise a stator and a rotor which are rotatably mounted with respect to one another. A mass of the rotor is, under certain circumstances, not distributed in a precisely rotationally symmetrical fashion, with the result that the rotor has an unbalance which may be static and/or dynamic. During operation of the electric motor, the unbalance causes vibrations, which inter alia can propagate in the form of solid-borne sound and can lead to increased noise and vibration loading. In order to reduce an unbalance of the rotor, the rotor has to be balanced. The rotor is preferably balanced together with a moving element which is connected to the rotor in a locking fashion in terms of torque and which is to be driven by the electric motor. The balancing process has to be carried out individually for each rotor, which increases manufacturing costs for the rotor, and therefore for the electric motor.

### SUMMARY OF THE INVENTION

The invention is based on the object of specifying a rotation element of an electric motor and a method for mounting the rotation element by means of which balancing can be carried out in a simplified way.

According to the invention, a rotation element of an electric motor comprises a rotor of the electric motor having a rotational axis and a moving element which is connected to the rotor in a locking fashion in terms of torque. An angle of inclination of the moving element with respect to the rotor is defined by bearing elements which are arranged on a circumference around the rotational axis of the rotor, wherein the bearing elements each define axial distances between the rotor and the moving element. Each bearing element is formed by a first axial section and a second axial section, and the moving element can be moved into different rotational positions with respect to the rotor in such a way that different pairings of first and second sections which correspond to different angles of inclination are produced.

By means of the angle of inclination, an oblique position can be brought about between the moving element and the rotor, which position can be used to compensate an unbalance. By simply rotating the moving element with respect to the rotor before the mounting of the moving element on the rotor it is therefore possible to reduce the unbalance. In this context, the number of adjustable angles of inclination is limited by the necessarily finite number of first and second sections, which can contribute to simplifying the balancing process.

Contact points at which the first sections respectively bear against the second sections can lie in a plane which is perpendicular to the rotational axis. As a result, for example, a moving element can be used whose sections which are assigned to it are all of the same length. This is a customary embodiment for many moving elements, with the result that sections of the bearing elements of different lengths have to be formed only on the rotor. In a corresponding way, the sections which are of the same length can also be formed on the rotor, and the sections which are of unequal length on the moving element.

First sections which are adjacent to one another can each enclose identical angles with one another with respect to the rotational axis. The moving element can then be rotated through this angle with respect to the rotor without changing the angle of inclination in the process. Second sections which are adjacent to one another and which can form a bearing element with the same first section can enclose identical angles with one another with respect to the rotational axis. By rotating the moving element with respect to the rotor through this angle, which can be smaller than the angle between the adjacent first sections, the size of the angle of inclination can be varied.

Taken together, the bearing elements can be arranged and embodied in such a way that depending on the rotational position as many different angles of inclination can be set as the number of second sections which can form a bearing element with one of the first sections, wherein each adjustable angle of inclination can be set with respect to each first section. This embodiment can be directly reproduced by a person mounting the moving element on the rotor with the result that balancing can be carried out by selective implementation.

One of the bearing elements can have a coaxial receptacle for a connecting element for bringing about the torque lock between the moving element and the fan. The bearing elements can therefore be used in an integrated fashion for the torque-locked connection. As a result, the complexity of the rotor and/or of the moving element can be reduced, which as a result permits manufacturing costs to be lowered.

The moving element and the rotor preferably have marks for identifying a rotational position. In one particularly preferred embodiment, the moving element is an impeller wheel.

In one method for reducing an unbalance of the described rotation element, in a first rotational position the moving element is attached to the rotor. The rotation element is rotated about the rotational axis and a first deviation from a run-out of the rotation element is determined. The moving element is subsequently rotated with respect to the rotor in such a way that the angle of inclination and/or the orientation of the angle of inclination with respect to the rotor is changed. Thereafter, the rotation element is rotated about the rotational axis again and a second deviation from the run-out of the rotation element is determined. On the basis of the first and the second deviation which is determined, an angle of inclination and an orientation of the moving element with respect to the rotor are determined in such a way that the deviation from the run-out of the rotation element is minimized. A rotational position of the moving element with respect to the rotor is determined as optimization of the angle of inclination at the determined angle of inclination, and of the orientation of the angle of inclination to the specific orientation. Finally, the moving element is attached in a locking fashion in terms of torque to the rotor in the determined rotational position.

Further parts of the method, such as the rotation of the rotation element, the determination of the deviations from the run-out, the determination of the angle of inclination and of the orientation as well as the determination of the rotational position can be carried out by machine or in an automated fashion. An assembly worker must simply insert the rotor and the moving element in different positions in a rotational device and subsequently carry out the mounting process of the moving element on the rotor in a predefined rotational position. As a result, the method can be carried out promptly and cost-effectively.

The rotation of the rotational element is preferably carried out by means of a device which is in engagement with the rotor on a side of the rotor facing away from the moving element. The device can engage with the rotor in the same way as the stator of the electric motor engages later.

### BRIEF DESCRIPTION OF THE DRAWINGS

The invention will now be described in more detail with respect to the appended figures, of which:

FIG. 1 shows a longitudinal section through an electric motor with an impeller wheel;

FIG. 2 shows a detail from FIG. 1;

FIG. 3 shows a rotor of the electric motor from FIGS. 1 and 2; and

FIG. 4 shows a flowchart of a method for mounting the electric motor in FIGS. 1 to 3.

### DETAILED DESCRIPTION

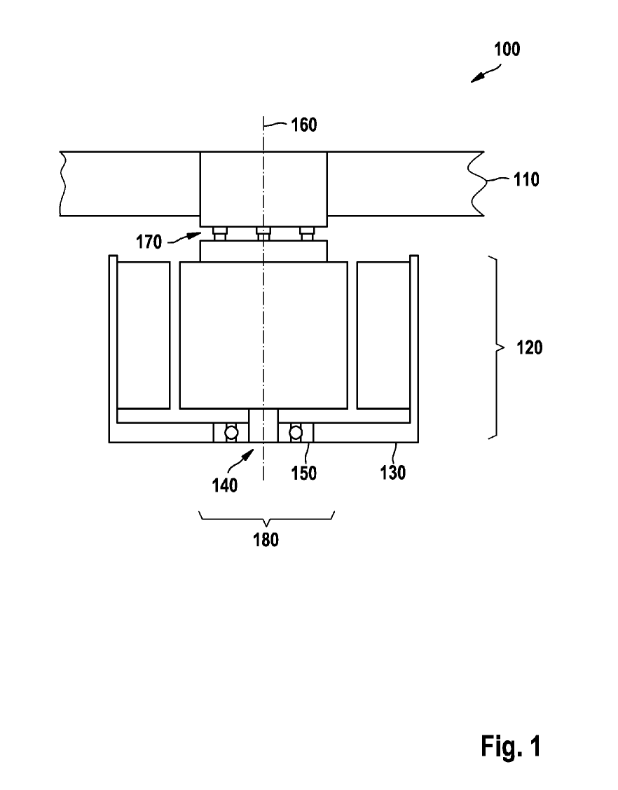

FIG. 1 shows a longitudinal section through an electric motor with an impeller wheel. A fan 100 comprises an impeller wheel 110 and an electric motor 120. The electric motor 120 is formed by a stator 130 and a rotor 140. A bearing 150 connects the stator 130 to the rotor 140 in such a way that the rotor 140 is mounted in such a way that it can rotate with respect to the stator 130 about a rotational axis 160. The impeller wheel 110 is connected in a locking fashion with respect to torque to the rotor 140 by means of a plurality of bearing elements 170.

The illustrated fan 100 serves merely as an example for explaining the invention. A specific design of the fan 100 and, in particular of the electric motor 120 is not intended to be implied thereby. It is, for example, irrelevant for the invention whether the electric motor 120 has permanent magnets and whether they are arranged on the stator 130 or on the rotor 140. The impeller wheel 110 is illustrated only in the region of the electric motor 120 since precise shaping of the blades of the impeller wheel 110 is likewise irrelevant for the invention.

The impeller wheel 110 and the rotor 140 together form a rotation element 180 which rotates about the rotational axis 160 during the operation of the electric motor 120. A static unbalance of the rotation element 180 occurs when a centroid axis of the rotation element 180 is offset in parallel with the rotational axis 160. A dynamic unbalance occurs if the rotational axis 160 encloses an angle with the centroid axis which is unequal to zero. Through selective oblique positioning of the impeller wheel 110 with respect to the rotor 140 it is possible, in particular, to reduce or compensate an existing dynamic unbalance of the rotation element 180.

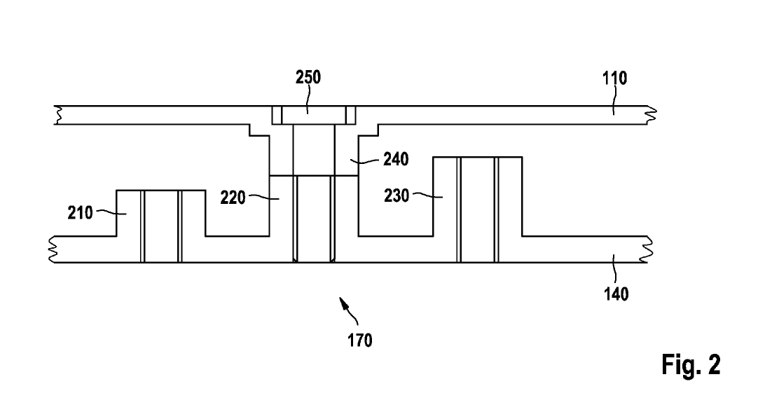

FIG. 2 shows a detail from FIG. 1 in the region of the bearing element 170. In the illustrated portion from FIG. 1, the rotor 140 has three bushings which extend to different degrees in the upward direction, specifically a short bushing 210, medium bushing 220 and a long bushing 230. The impeller wheel 110 has a downward-extending counter-bushing 240. The counter-bushing 240 bears axially against the medium bushing 220 and forms one of the bearing elements 170 from FIG. 1 together with said medium bushing 220. A screw 250 is guided through the counter-bushing 240 and the medium bushing 220. The three bushings of the rotor 140 have internal threads, with the result that the screw 250 secures the impeller wheel 110 with the rotor 140 in the axial direction. In other embodiments, a self-tapping screw can also be used. The torque lock between the impeller wheel 110 and the rotor 140 is mainly produced by frictional forces in the region of the counter-bushing 240 and the medium bushing 220 which adjoin one another.

The counter-bushing 240 can be brought into abutment with any of the other bushings 210 to 230. As a result, a distance between the impeller wheel 110 and the rotor 140 in the region of the bearing element 170 is changed. Depending on which other distances are defined by the further bearing elements 170 between the impeller wheel 110 and the rotor 140, different angles of inclination can therefore be set between the impeller wheel 110 and the rotor 140 from FIG. 1. In this context, the angle of inclination is an angle which occurs between the rotational axis 160 and a further axis, which is positionally fixed with respect to the impeller wheel 110, wherein the positionally fixed axis corresponds to the rotational axis 160 if all the bearing elements 170 define identical distances between the impeller wheel 110 and the rotor 140. Alternatively, the angle of inclination can also be defined between a centroid axis of the impeller wheel 110 and the rotational axis 160 of the rotor 140.

In a further embodiment, illustrated in a corresponding way to that in FIG. 2, a plurality of bushings of different lengths are attached to the impeller wheel 110, and a corresponding counter-bushing is attached to the rotor 140. In yet another embodiment, the bushings 210-230 comprise equalizing elements which define the different lengths of the bushings. The equalizing elements can be spacer washers or shims.

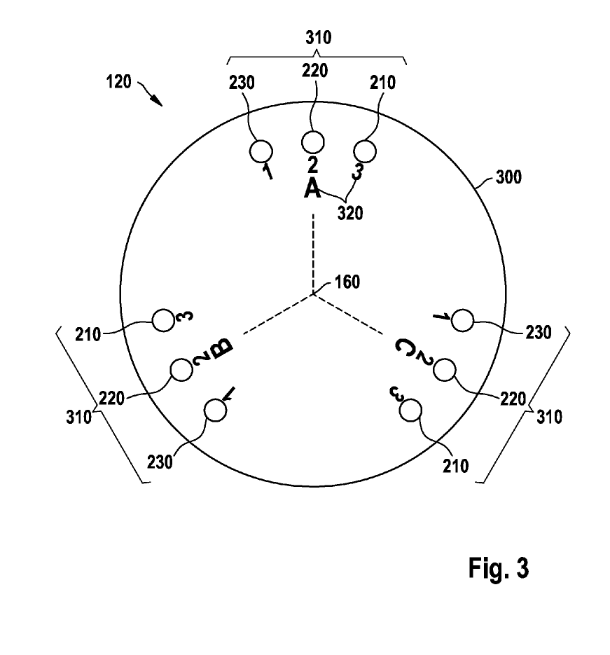

FIG. 3 show a rotor element 300 of the rotor 140 from FIGS. 1 and 2. The rotor element 300 is that section of the rotor 140 on which the bushings 210 to 230 of the rotor 140 are formed in order to produce the bearing elements 170.

In each case three short bushings 210, three medium bushings 220 and three long bushings 230 are arranged on a circular circumference around the rotational axis 160, wherein in each case three bushings 210 to 230 of different lengths form a group 310. Marks 320, which denote the different groups 310 or the different bushings 210 to 230 of the respective groups 310, are provided on the rotor element 300. For example, the medium bushing 220 illustrated at the 12 o'clock position, is denoted as A2 by means of the marks 320.

The designation of each of the bushings 210 to 230 in each of the groups 310 is clear. In the text which follows, the symbols used in FIG. 3 are therefore used.

Angles which are enclosed between bushings 210 to 230, which are of equal length, of different groups 310, for example between A1 and B2, are identical and are 120°. At least three bearing elements 170 are necessary to clearly define the angle of inclination between the impeller wheel 110 and the rotor 140. For this reason, no fewer than three groups 310 of bushings 210 to 230 are preferably provided, but the number of groups 310 can also be larger than three. Identical angles, of the order of magnitude of approximately 20° in the illustration in FIG. 3 also lie between adjacent bushings 210 to 230 of each group 310.

The impeller wheel 110 has counter-bushings 240 which are also offset with respect to one another by 120° with respect to the rotational axis 160 and lie on a corresponding circular circumference to that of the bushings 210 to 230 of the groups 310. One of the counter-bushings 240 has a mark, with the result that by specifying a position on the hub 300, for example A2, a clear rotational position is defined in which the marked counter-bushing 240 is aligned with the bushing 220 in the position A2 on the hub 300 of the rotor 120.

In one exemplary embodiment, heights of the bushings 210 to 230 are distributed in the following table:

| Position | Relative height |
|---|---|
| A1 | +1 |
| A2 | 0 |
| A3 | +2 |
| B1 | −1 |
| B2 | 0 |
| B3 | −2 |
| C1 | −1 |
| C2 | 0 |
| C3 | −2 |

The relative heights which are given in the table are converted into absolute heights by a common factor. The factor can be, for example, 0.1 mm. The absolute heights relate here to the bushings 210 to 240; an absolute height at an external diameter of the impeller wheel 110 may be larger in accordance with the lever ratios.

If the marked counter-bushing 240 of the impeller wheel 110 is placed in alignment with, for example, the bushing at the position A3, the other counter-bushings 240 of the impeller wheel 110 bear against the bushings with the positions B3 and C3. The oblique position or the angle of inclination between the impeller wheel 110 and the rotor 140 is produced according to the diameter of the impeller wheel 110 and the scaling of the relative height to absolute height differences. At the positions A2, B2 and C2, the angle of inclination is the same, specifically V In a specific example, as a result an oblique positioning of 0.6 mm is achieved at an outer edge of the impeller wheel 110 with an external diameter of 500 mm, as a result of which approximately 20,000 g·mm² unbalance can be compensated.

In other embodiments, other relative heights are possible, in particular the possibility of the counter-bushings 240 of the impeller wheel 110 having different lengths is not excluded.

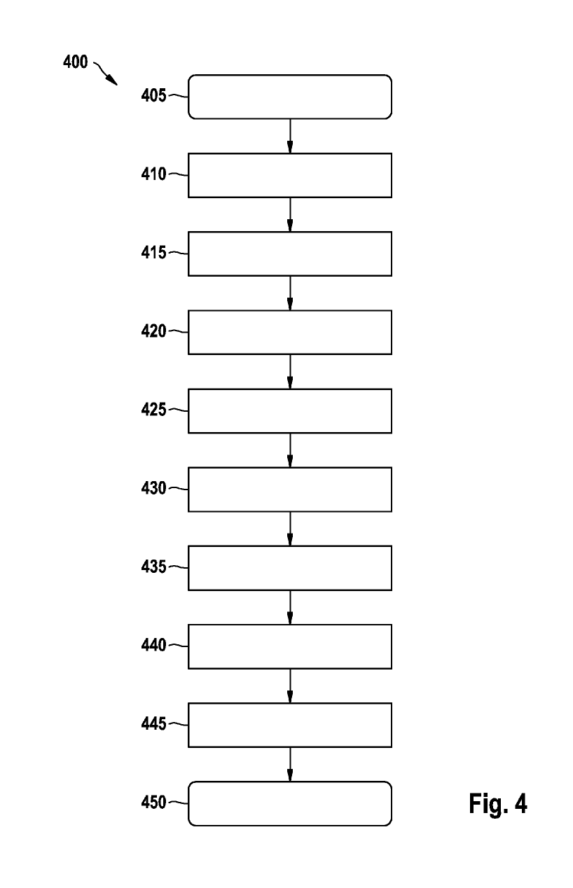

FIG. 4 shows a flow chart of a method 400 for mounting the rotation element 180 or the electric motor 120 in FIGS. 1 to 3. The method 400 comprises steps 405 to 450.

In the step 405, the method 400 is in the starting state. In step 410, the impeller wheel 120 is attached to the rotor 140, with the result that the rotation element 180 is produced. In the step 415, the rotation element 180 is rotated about its rotational axis 160. For this purpose, a rotational device can be used which is either connected to the impeller wheel 110 or to the rotor 140. In this context, the bearing 150 can already be attached to the stator 140. The run-out is determined by sensing an axial variation at an outer circumference of the impeller wheel 110. In another embodiment, the rotational device can be mounted in a sprung fashion, and in step 160 a rotational-angle-related deflection of the rotational device in the direction of the suspension can be determined during the rotation.

Subsequently in step 420 the impeller wheel 110 is rotated on the rotor 140 with the result that another angle of inclination and/or another orientation of the angle of inclination between the impeller wheel 110 and the rotor 140 is set. In the step 425, the run-out of the rotation element 180 is determined again, as is stated above with respect to step 415.

In step 430, an angle of inclination and an orientation, which the impeller wheel 110 ideally assumes with respect to the rotor 140 in order to minimize the deviations from the run-out of the rotation element 180, are determined on the basis of the measured values which are acquired in steps 415 and 425. On the basis of these requirements, in step 435 the rotational position of the impeller wheel 110 with respect to the rotor 140 is determined. In the step 440, the impeller wheel 110 is mounted in the determined rotational position on the rotor 140, for example by means of the screws 250 in FIG. 2.

In the optional step 445, the rotation element 180 is mounted on the stator 130 of the electric motor 120. In an alternative embodiment, the impeller wheel 110 can also be temporarily removed from the rotor 140 in order to mount the rotor 140 on the stator 130. The already determined rotational position can be brought about during the subsequent mounting of the impeller wheel 110 on the rotor 140, for which purpose the marks 320 can be helpful.

The method 400 is subsequently in the final state 450.

1. A rotation element (180) of an electric motor, comprising:
a rotor (140) having a rotational axis (160); and
a moving element (110) which is connected to the rotor in a locking fashion in terms of torque;
wherein an angle of inclination of the moving element (110) with respect to the rotor (140) is defined by bearing elements (170) which are arranged on a circumference around a rotational axis (160), wherein the bearing elements (170) each define axial distances between the rotor (140) and the moving element (110); and
wherein each bearing element (170) is formed by a first axial section (240) and a second axial section (210-230), and the moving element (110) can be moved into different rotational positions with respect to the rotor (140) in such a way that different pairings of first (240) and second (210-230) sections which correspond to different angles of inclination are produced.

2. The rotation element (180) according to claim 1, characterized in that contact points at which the first sections (240) respectively bear against the second sections (210-230) lie in a plane which is perpendicular to the rotational axis (160).

3. The rotation element (180) according to claim 1, characterized in that first sections (240) which are adjacent to one another each enclose identical angles with one another with respect to the rotational axis (160).

4. The rotation element (180) according to claim 1, characterized in that second sections (210-230) which are adjacent to one another and which can form a bearing element (170) with the same first section (240) enclose identical angles with one another with respect to the rotational axis (160).

5. The rotation element (180) according to claim 3, characterized in that the bearing elements (170) are arranged and embodied in such a way that depending on a rotational position as many different angles of inclination can be set as the number of second sections (210-230) which can form a bearing element (170) with one of the first sections (240), wherein each adjustable angle of inclination can be set with respect to each first section (240).

6. The rotation element (180) according to claim 1, characterized in that one of the bearing elements (170) has a coaxial receptacle for a connecting element (250) for bringing about torque lock between the moving element (110) and the rotor (140).

7. The rotation element (180) according to claim 1, characterized in that the moving element (110) and the rotor (140) have marks for identifying a rotational position.

8. The rotation element (180) according to claim 1, characterized in that the moving element (110) is an impeller wheel.

9. A method (400) for reducing an unbalance of a rotation element (180) according to claim 1, comprising the following steps:
attaching the moving element (110) to the rotor (140) in a first rotational position;
rotating the rotation element (180) about the rotational axis (160) and determining a first deviation from a run-out of the rotation element (180);
rotating the moving element (110) with respect to the rotor (140) in such a way that at least one of the angle of inclination and an orientation of the angle inclination with respect to the rotor (160) is changed;
rotating the rotation element (180) about the rotational axis (160) and determining a second deviation from the run-out of the rotation element (180);
determining an angle of inclination and an orientation of the moving element (110) with respect to the rotor (140) on the basis of the first and second deviation such that the deviation from the run-out of the rotation element (180) is minimized;
determining of a rotational position of the moving element (110) with respect to the rotor (140) as optimization of the angle of inclination at the determined angle of inclination and the orientation of the angle of inclination to the specific orientation; and
attaching in a torque-locking manner the moving element (110) to the rotor (140) in the determined rotational position.

10. The method (400) according to claim 9, wherein the rotation (415, 425) of the rotation element (180) is carried out by a device which is in engagement with the rotor (140) on a side of the rotor (140) facing away from the moving element (110).
